(19) United States
(12) Patent Application Publication
(10) Pub. No.: US 2006/0190094 A1
(43) Pub. Date: Aug. 24, 2006

(54) Coupling device for three bus systems

(76) Inventors: Patrick Gehlen, Grossenbuch (DE); Werner Kramer, Schwandorf (DE); Bernhard Wiesgickl, Vilseck (DE); Roman Wunschik, Zirndorf (DE)

Correspondence Address: HARNESS, DICKEY & PIERCE, P.L.C., P.O.BOX 8910, RESTON, VA, 20195, US

(21) Appl. No.: 10/565,276

(22) PCT Filed: Jul. 2, 2004
(86) PCT No.: PCT/EP04/07251

§ 371 Date: Jan. 20, 2006

(30) Foreign Application Priority Data
Jul. 22, 2003 (EP) 03016734.0

(51) Int. Cl. G05B 15/00

(52) U.S. Cl. 700/1

(57) ABSTRACT

Coupling of bus systems is simplified. To this end, a coupling device is disclosed that is used to couple two field buses to a periphery bus. The periphery bus can be used to connect input/output modules for the central monitoring or processing of data. For example, the coupling device can be configured in terms of the transfer of standard data and security-relevant data between the three bus systems.

This application is the national phase under 35 U.S.C. §371 of PCT International Application No. PCT/EP2004/007251 which has an International filing date of Jul. 2, 2004, which designated the United States of America and which claims priority on European Patent Application number EP 03016734.0 filed Jul. 22, 2003, the entire contents of which are hereby incorporated herein by reference.

### FIELD

The present invention generally relates to a coupling apparatus for data buses having a first connecting device for a first data bus, a second connecting device for a second data bus, which is not the same as the first, and a data processing device, which is connected to the first and the second connecting device in order to allow data to be interchanged between the data buses.

### BACKGROUND

In numerous applications, there is a requirement to couple different bus systems. In this context, a distinction frequently has to be drawn between standard data and safety-relevant or security-relevant data for data transmission between the bus systems.

So-called links are used, as is known, for coupling different bus systems. However, these links are not configurable. Furthermore, input/output assemblies (I/Os) must be connected to one of the two bus systems in order to input and/or output data directly. This results in additional costs, reduces the reaction times, and loads the computation power of the programmable logic controllers (PLCs). These disadvantages affect in particular assemblies for safety-relevant or security-relevant data, since correspondingly fast reaction times are required there.

### SUMMARY

An object of at least one embodiment of the present invention is thus to propose a coupling apparatus for bus systems, in which it is possible to input and output data in the immediate vicinity of the apparatus without significantly reducing the system reaction times or significantly loading the system.

According to at least one embodiment of the invention, this object may be achieved by a coupling apparatus for data buses having a first connecting device for a first data bus, a second connecting device for a second data bus, which is not the same as the first, and a data processing device, which is connected to the first and the second connecting device in order to allow data to be interchanged between the data buses, as well as a third connecting device, which is likewise connected to the data processing device, for a third data bus, which is not the same as the first and second data buses, so that data can be interchanged between the three data buses.

At least one embodiment of the invention thus makes it possible for a central module to access data from three or more bus systems.

The coupling apparatus according to at least one embodiment of the invention is advantageously configurable. In particular, this allows a configuration process which makes it possible to distinguish between data which is intended to be transmitted between the bus systems. In particular, the coupling apparatus can be configured in such a way that the data transfer between two or three of the data buses can be controlled as a function of the semantics of the data to be transmitted. For example, it is possible to configure the transmission of standard data differently to that for the transmission of safety-relevant or security-relevant data.

The first data bus to which the coupling apparatus is connected may be a so-called Profibus. The second data bus may, for example, be an AS-i bus.

The third data bus to which the coupling apparatus according to at least one embodiment of the invention can be connected may be a peripheral bus, to which input/output modules can be connected. These modules are data to be input to and output from the link. The input/output modules may be linked to the other data buses by means of the link and the coupling apparatus. However, the third data bus may also be used in order to connect a plurality of coupling apparatus to one another.

A monitor for monitoring the configuration settings and/or the data transfer can be integrated in the coupling apparatus. In particular, the monitor is intended to identify and further process safety-relevant and security-relevant data.

### BRIEF DESCRIPTION OF THE DRAWINGS

Example embodiments of the present invention will now be explained in more detail with reference to the following detailed description and the attached drawings, in which: FIG. 1 shows an outline circuit diagram of a coupling apparatus according to at least one embodiment of the invention;

FIG. 2 shows a data flowchart of a coupling apparatus according to at least one embodiment of the invention;

FIG. 3 shows a data flowchart of a coupling of a plurality of fieldbus systems;

FIG. 4 shows a data flowchart of a coupler with input/output assemblies;

FIG. 5 shows a data flowchart of a coupler for two fieldbus systems without any further circuitry; and

FIG. 6 shows a configuration example on the data flowchart shown in FIG. 4.

The embodiments described in more detail in the following text represent example embodiments of the present invention.

### DETAILED DESCRIPTION OF THE EXAMPLE EMBODIMENTS

As shown in FIG. 1, the coupling apparatus according to at least one embodiment of the invention and the data coupler 1 according to at least one embodiment of the invention can be connected between two fieldbuses F1 and F2. Furthermore, the data coupler 1 has a connection to an internal peripheral bus P. The data coupler 1 can be configured via the internal peripheral bus P for data transfer between the fieldbuses F1 and F2 and for data transfer between the peripheral bus and the fieldbuses.

FIG. 2 shows the data flow which is possible between the three buses F1, F2 and P. In addition to standard data S, safety-relevant or security-relevant data F can also be interchanged via the data buses. In this case, the safety-relevant or security-relevant data and/or standard data can be output on the buses F1 and F2 via an output unit to the peripheral bus, and/or safety-relevant or security-relevant data and/or standard data can be read in via an input unit from the peripheral bus, and can be passed on to the buses F1 and/or F2.

FIG. 3 shows the coupling of two fieldbus systems F1, F2 and F1*, F2* via the peripheral bus P. For this purpose, a first data coupler 1 and a second data coupler 2 are connected to one another via their peripheral bus interface. In consequence, all four fieldbuses F1, F2, F1* and F2* can interchange standard data S as well as safety-relevant and security-relevant data F with one another. In this case as well, the two data couplers 1 and 2 can be configured as required for data transfer of standard data and safety-relevant or security-relevant data.

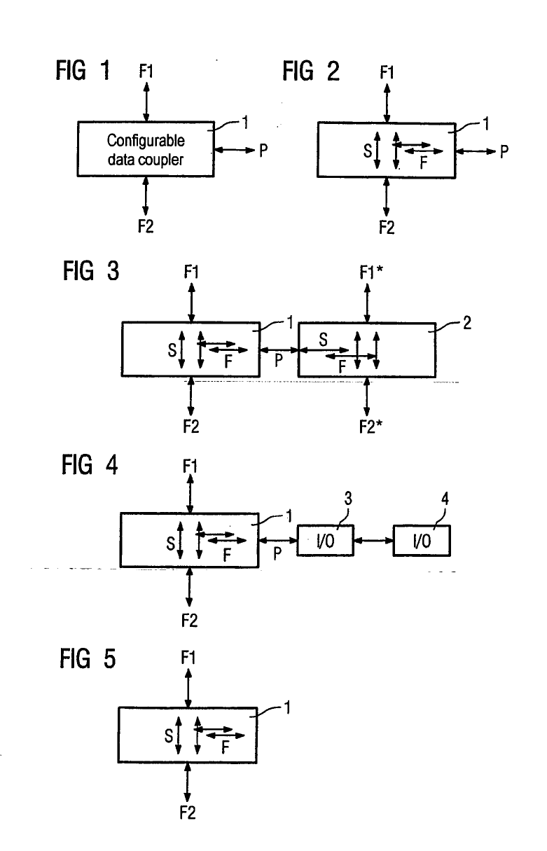

FIG. 4 shows the data flowchart for one particularly preferred configuration. The data coupler 1 is connected via the peripheral bus P to a plurality of input/output assemblies 3, 4. Information can be output from the other buses or input to them via these assemblies 3, 4. An appropriate configuration allows not only the definition of the data as mentioned above, which is transmitted between the connected data buses, but also allows individual in-situ processing of the data. With an appropriate hardware and software configuration, safety-relevant or security-relevant data can also be transmitted and/or processed.

The direct connection of the input/output assemblies 3, 4 via the peripheral bus P to the data coupler 1 means that there is no need to connect such assemblies to the fieldbuses F1 and F2 in the vicinity of the data coupler 1. This makes it possible, for example, to reduce the load on the PLC of a Profibus.

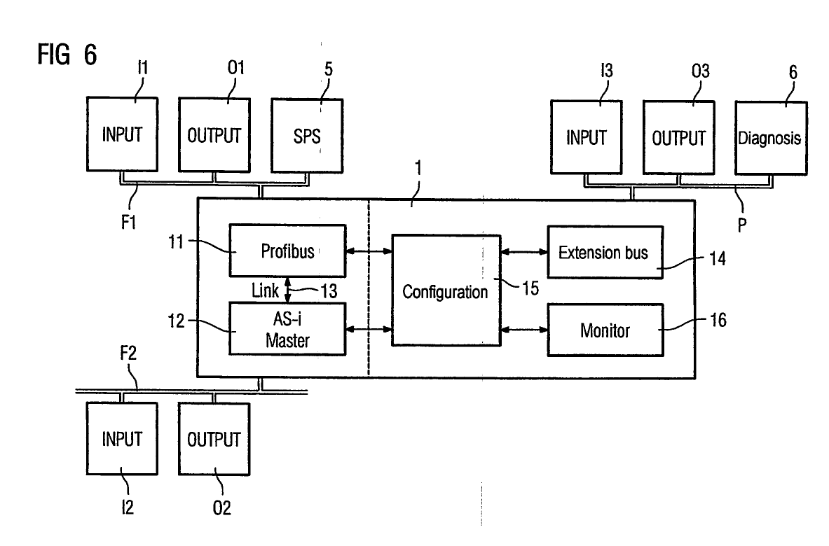

FIG. 5 shows the data flowchart for a pure coupler by which the fieldbuses F1 and F2 are coupled. The data transfer between the two buses can be provided via the configurable data coupler 1 as in the previous exemplary embodiments. No further input/output assemblies are provided in this case.

As the above example embodiments show, a plurality of bus systems can be coupled very flexibly according to at least one embodiment of the invention. Furthermore, the system costs can be reduced, since the wiring complexity is reduced.

In addition, the reaction times of the system according to at least one embodiment of the invention are shortened, since no input/output assemblies are arranged between the data coupler and the PLC for a Profibus. Furthermore, the load on the PLC is reduced when no additional I/Os are arranged in the Profibus. In addition, the configurable data coupler allows a large number of different appliance variants to be set up with little effort. Examples of this, some of which have already been mentioned, include a single coupler, a coupler for safety-relevant or security-relevant data and configurable I/Os for safety-relevant or security-relevant data.

FIG. 6 illustrates one specific example embodiment of a plurality of data buses which are connected to the coupling apparatus according to at least one embodiment of the invention. The data coupler 1 has a Profibus interface 11 to a Profibus as a fieldbus F1, and an AS-i master 12 as an interface to an AS-i bus as the fieldbus F2. The Profibus interface 11 and the AS-i master 12 are connected to one another via a link 13. An extension or peripheral bus interface 14 is used for connection of the data coupler 1 to the peripheral bus P. All of the interfaces 11, 12 and 14 are configurable via an internal configuration unit 15. The data coupler 1 also has a monitor 16, which can be used to monitor the configuration and/or the data transfer.

An input module I1 and an output module O1 as well as a PLC 5 are connected in a known manner to the Profibus F1. An input module I1 and an output module O2 are connected in a similar manner to the AS-i bus F2. Furthermore, an input module I3 and an output module O3 as well as a diagnosis unit 6 are connected to the peripheral bus P. The components located on the peripheral bus P can be configured via the data coupler 1.

Thus, in addition to a Profibus/AS-I bus link with an internal communication interface, the coupling apparatus according to at least one embodiment of the invention makes it possible to provide a pure AS-i safety or security monitor with an internal communication interface for connection of further I/O modules, with any desired number of outputs. Furthermore—as has already been partially described above—the coupling apparatus according to at least one embodiment of the invention makes it possible to provide AS-i safety or security monitors with an internal communication interface for connection of further I/O modules and with a Profibus connection as a configuration interface and diagnosis unit, or with an AS-i connection or with a Profibus/Profisafe and AS-i connection. The so-called Profisafe also allows the transmission of safety-relevant or security-relevant data. Finally, the coupling apparatuses according to at least one embodiment of the invention, which each have at least three bus connections, can be used to produce data networks with any desired number of bus systems.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A coupling apparatus for data buses, comprising:
a first connecting device for a first data bus;
a second connecting device for a second data bus, as additional to the first connecting device;
a data processing device, connected to the first and the second connecting device to allow data to be interchanged between the data buses; and
a third connecting device, connected to the data processing device, for a third data bus, as additional to the first and second data buses, to allow data to be interchanged between the three data buses.

2. The coupling apparatus as claimed in claim 1, wherein the coupling apparatus is configurable.

3. The coupling apparatus as claimed in claim 2, wherein the coupling apparatus is configurable in such a way that the data transfer between at least two of the data buses is controllable as a function of the semantics of the data to be transmitted.

4. The coupling apparatus as claimed in claim 1, wherein the first data bus is a Profibus.

5. The coupling apparatus as claimed in claim 1, wherein the second data bus is an AS-i bus.

6. The coupling apparatus as claimed in claim 1, wherein at least one of input and output modules are connectable to the third data bus and are linkable to at least one of the first and the second data bus with the aid of the coupling apparatus.

7. The coupling apparatus as claimed in claim 1, including a monitor with a configuration capability.

8. The coupling apparatus as claimed in claim 2, wherein the first data bus is a Profibus.

9. The coupling apparatus as claimed in claim 2, wherein the second data bus is an AS-i bus.

10. The coupling apparatus as claimed in claim 3, wherein the first data bus is a Profibus.

11. The coupling apparatus as claimed in claim 3, wherein the second data bus is an AS-i bus.

12. The coupling apparatus as claimed in claim 4, wherein the second data bus is an AS-i bus.

13. The coupling apparatus as claimed in claim 2, wherein input/output modules are connectable to the third data bus and are linkable to at least one of the first and the second data bus with the aid of the coupling apparatus.

14. The coupling apparatus as claimed in claim 1, including a monitor with a configuration capability.
